(19) United States
(12) Patent Application Publication
(10) Pub. No.: US 2023/0252389 A1
(43) Pub. Date: Aug. 10, 2023

(54) ENTERPRISE ACTIVITY EVALUATION SYSTEM DEALING WITH ENVIRONMENTAL MANAGEMENT, AND ITS METHOD AND PROGRAM

(71) Applicant: Backcasting Technology Research & Institute, Inc., Osaka (JP)

(72) Inventors: Kazutoshi KASAGI, Saitama (JP); Tatsuya FUJII, Hyogo (JP); Tadanori RYU, Fukuoka (JP)

(21) Appl. No.: 18/014,911

(22) PCT Filed: Dec. 23, 2021
(86) PCT No.: PCT/JP2021/047773

§ 371 Date: Jan. 6, 2023

(30) Foreign Application Priority Data
Apr. 7, 2021 (JP) 2021-065524

(51) Int. Cl. G06Q 10/0637

(52) U.S. Cl. CPC G06Q 10/06375

(57) ABSTRACT

Provided is a novel technique for improving the efficiency of and simplifying evaluation of enterprise activities dealing with environmental management.

An enterprise activity evaluation system for enterprise activities dealing with environmental management, the enterprise activity evaluation system including: a reception unit; a storage unit; a boundary determination unit; and an evaluation unit, wherein the reception unit receives input of enterprise activity information including a subject and a detailed item, and its expense, the detailed item having a hierarchical structure including at least a detailed item whose parent is the subject, and a detailed item whose parent is the detailed item, the storage unit stores, in a non-volatile recording medium, a calculation coefficient for calculating a GHG emission amount based on the expense, the calculation coefficient being associated with the subject or the detailed item, and boundary information indicating the subject or the detailed item that corresponds to an evaluation target and the subject or the detailed item that does not correspond to the evaluation target with respect to an evaluation index of environmental management, the boundary information indicating the correspondence/non-correspondence to the evaluation target of at least GHG calculation, the boundary determination unit determines whether each record of the enterprise activity information corresponds or does not correspond to the evaluation target based on the boundary information, and the evaluation unit determines an economic cost indicating the expense of the enterprise activity information, and determines, based on the calculation coefficient, an environmental cost indicating the GHG emission amount for each record determined to correspond to the evaluation target of the GHG calculation.

### TECHNICAL FIELD

The present invention relates to an enterprise activity evaluation system dealing with environmental management, and its method and program.

### BACKGROUND ART

The sustainable development goals (SDGs), the task force on climate-related financial disclosures (TCFD), and the life cycle assessment (LCA) are useful indicators or methods for addressing problems including environmental cost reduction in enterprise activities by sound development of environmental and energy industry and creation of life style design while considering technology development and social acceptability.

According to Non Patent Literature 1, however, among small and medium enterprises, the proportion of small and medium enterprises that do not recognize the SDGs has occupied 84.2% in the past. Therefore, a policy to increase the degree of recognition of the SDGs by the small and medium enterprises, which occupy the majority of enterprises, is important in achieving the SDGs, and is an opportunity to promote efforts for environmental management. The “environmental management” refers to management according to social requirements for Environment, Social, Governance (ESG).

In addition, according to Non Patent Literature 1, the small and medium enterprises list points such as “social recognition of the SDGs themselves has not increased”, “shortage of funds”, and “shortage of manpower” as problems in dealing with the SDGs. Therefore, a need exists for a technique for improving the efficiency of and simplifying the efforts for the environmental management in enterprises and supporting the start of the activities.

The invention described in Patent Literature 1 relates to a life cycle environment evaluation system including storage means for storing an environmental impact of a product or a component, and storage means for storing an environmental impact in each process at a manufacturing site, in which an environmental impact of a product is obtained from product information based on a set of component information on the storage means and process information on the storage means. In the life cycle environment evaluation system, the process information has basic units of energy consumption such as electricity in the respective processes, and LCA/energy evaluation means is provided that calculates an evaluation index of the environmental impact of the product based on the component information and the process information on the product information, and calculates energy consumption of the product based on the energy consumption in each process.

The invention described in Patent Literature 1 makes it possible to visualize the evaluation index regarding the environmental management in conjunction with the manufacturing activities. However, the invention does not evaluate enterprise activities other than the manufacturing activities.

The invention described in Patent Literature 2 is an evaluation method for enterprise activities, the method including: receiving input of actual values with respect to a target value of performance and a target value of a KAITEKI index; obtaining an evaluation value with respect to a target value of a YK value indicated by a combination of the actual value of the performance and the actual value of the KAITEKI index according to a degree of achievement of an actual value of the YK value; and obtaining a predictive value of the performance, a predictive value of the KAITEKI index, or a predictive value of the YK value after a predetermined period based on the target value of the enterprise performance, the actual value with respect to the target value of the enterprise performance, the target value of the KAITEKI index, and the actual value with respect to the target value of the KAITEKI index.

However, in the invention described in Patent Literature 2, a workload of tabulating information resources in an enterprise in a predetermined format is high, and there is still room for improvement of efficiency and simplification in the enterprise activity evaluation. In addition, from another point of view, it is difficult to utilize the evaluation method unless a user deepens his/her understanding of problems and fully understands the information resources in the enterprise and a way to deal with the problems.

The invention described in Patent Literature 3 relates to a transportation management supporting system, and includes a transportation distance management DB, a distribution result calculation unit, a distribution simulation unit, an LCA calculation unit, and an emission material simulation unit. The transportation distance management DB stores physical distribution data. The distribution result calculation unit calculates distribution result data based on the physical distribution data. The distribution simulation unit calculates and outputs a first reduction rate of physical distribution costs in physical distribution cost reduction measure data. In addition, a third reduction rate of physical distribution costs in emission material reduction measure data is calculated and output. The LCA calculation unit calculates emission material emitting result data based on the physical distribution data. The emission material simulation unit calculates and outputs a second reduction rate of emission material emitting quantities in the emission material reduction measure data. A fourth reduction rate of emission material emitting quantities in the physical distribution cost reduction measure data is calculated and output. The invention has the features as described above. Therefore, the invention can be grasped as easily calculating the effects of the physical distribution cost reduction measure and the emission material quantity reduction measure, and as further easily calculating the mutual influence between them.

The invention described in Patent Literature 3 makes it possible to visualize the evaluation index regarding the environmental management in the physical distribution. However, the invention does not evaluate enterprise activities other than the physical distribution activities.

### CITATION LIST

### Patent Literature

Patent Literature 1: JP 2005-031743 A
Patent Literature 2: JP 2012-138060 A
Patent Literature 3: JP 2004-302541 A

### Non Patent Literature

Non Patent Literature 1: Kanto Bureau of Economy, Trade and Industry of the Ministry of Economy, Trade and Industry & General Incorporated Foundation, Japan Industrial Location Center “Survey on the level of awareness and present situation surrounding the SDGs in small- and medium-sized enterprises (online questionnaire)”, December 2018

### SUMMARY OF INVENTION

### Technical Problem

In view of the above circumstances, it is an object of the present invention to provide a novel technique for improving the efficiency of and simplifying evaluation of enterprise activities dealing with environmental management.

### Solution to Problem

In order to achieve the above object, the present invention is an enterprise activity evaluation system for enterprise activities dealing with environmental management,

the enterprise activity evaluation system including: a reception unit; a storage unit; a boundary determination unit; and an evaluation unit,

wherein the reception unit receives input of enterprise activity information including a subject and a detailed item, and its expense,

the detailed item having a hierarchical structure including at least a detailed item whose parent is the subject, and a detailed item whose parent is the detailed item,

the storage unit stores, in a non-volatile recording medium, a calculation coefficient for calculating a GHG emission amount based on the expense, the calculation coefficient being associated with the subject or the detailed item, and

boundary information indicating the subject or the detailed item that corresponds to an evaluation target and the subject or the detailed item that does not correspond to the evaluation target with respect to an evaluation index of environmental management, the boundary information indicating the correspondence/non-correspondence to the evaluation target of at least GHG calculation,

the boundary determination unit determines whether each record of the enterprise activity information corresponds or does not correspond to the evaluation target based on the boundary information, and

the evaluation unit determines an economic cost indicating the expense of the enterprise activity information, and

determines, based on the calculation coefficient, an environmental cost indicating the GHG emission amount for each record determined to correspond to the evaluation target of the GHG calculation.

The present invention is an enterprise activity evaluation program for enterprise activities dealing with environmental management,

the program causing a computer to function as: a reception unit; a storage unit; a boundary determination unit; and an evaluation unit,

wherein the reception unit receives input of enterprise activity information including a subject and a detailed item, and its expense,

the detailed item having a hierarchical structure including at least a detailed item whose parent is the subject, and a detailed item whose parent is the detailed item,

the storage unit stores a calculation coefficient for calculating a GHG emission amount based on the expense, the calculation coefficient being associated with the subject or the detailed item, and

boundary information indicating the subject or the detailed item that corresponds to an evaluation target and the subject or the detailed item that does not correspond to the evaluation target with respect to an evaluation index of environmental management, the boundary information indicating the correspondence/non-correspondence to the evaluation target of at least GHG calculation,

the boundary determination unit determines whether each record of the enterprise activity information corresponds or does not correspond to the evaluation target based on the boundary information, and

the evaluation unit determines an economic cost indicating the expense of the enterprise activity information, and

determines, based on the calculation coefficient, an environmental cost indicating the GHG emission amount for each record determined to correspond to the evaluation target of the GHG calculation.

The present invention is an enterprise activity evaluation method for enterprise activities dealing with environmental management,

the method causing an enterprise activity evaluation system to execute: a reception step; a storage step; a boundary determination step; and an evaluation step,

wherein at the reception step, input of enterprise activity information including a subject and a detailed item, and its expense is received,

the detailed item having a hierarchical structure including at least a detailed item whose parent is the subject, and a detailed item whose parent is the detailed item,

at the storage step, a calculation coefficient for calculating a GHG emission amount based on the expense, the calculation coefficient being associated with the subject or the detailed item, and

boundary information indicating the subject or the detailed item that corresponds to an evaluation target and the subject or the detailed item that does not correspond to the evaluation target with respect to an evaluation index of environmental management, the boundary information indicating the correspondence/non-correspondence to the evaluation target of at least GHG calculation are stored in a non-volatile recording medium,

at the boundary determination step, whether each record of the enterprise activity information corresponds or does not correspond to the evaluation target is determined based on the boundary information, and

at the evaluation step, an economic cost indicating the expense of the enterprise activity information is determined, and

an environmental cost indicating the GHG emission amount for each record determined to correspond to the evaluation target of the GHG calculation is determined based on the calculation coefficient.

With such a configuration, when the enterprise activity information having the subject and the detailed item, and its expense is input, it is possible to determine the correspondence/non-correspondence to the evaluation target based on the boundary information. Regardless of the industry type, any enterprise holds the enterprise activity information having the subject and the detailed item, and its expense. Therefore, even if a user does not sufficiently understand the evaluation index of the environmental management and cannot sufficiently understand the information necessary for the evaluation, it is possible to efficiently and easily evaluate the enterprise activities dealing with the environmental management.

In a preferred mode of the present invention, the boundary determination unit performs the determination and adds a model coefficient to the record having the subject or the detailed item that does not fall under either of the correspondence/non-correspondence, and

the evaluation unit determines the environmental cost based on the model coefficient for the record where the model coefficient is set.

With such a configuration, it is possible to more accurately grasp the GHG emission amount with respect to the enterprise activity information. More specifically, it is possible to reflect the record where the subject or the detailed item that does not fall under either of the correspondence/non-correspondence to the evaluation target is set, in a totalization result by adding the model coefficient based on the boundary information. That is, even in a case where information is insufficient or unclear information is included in the subject or the detailed item input as the enterprise activity information, such as cases where the detailed item is blank, where transportation means related to a transportation expense is not included in the detailed item, or where the number of staying days related to a business tip expense is unknown, the environmental cost can be estimated by adding the model coefficient, and can be included in the totalization result of the environmental cost.

In a preferred mode of the present invention, the boundary determination unit determines the model coefficient to be added to the record having the subject or the detailed item that does not fall under either of the correspondence/non-correspondence based on the evaluation index and one or more of the associated subject and detailed item.

With such a configuration, the model coefficient can be added according to the evaluation index, the subject, and the detailed item associated with the record, so that the estimation accuracy of the environmental cost can be further enhanced.

In a preferred mode of the present invention, the enterprise activity evaluation system further includes a case provision unit,

wherein the storage unit stores environmental activity case information in which an environmental activity case and the subject or the detailed item corresponding to the case are associated with each other,

the evaluation unit totalizes the GHG emission amount in the enterprise activity information based on the subject or the detailed item, and

the case provision unit determines a target subject or a target detailed item whose totalization result exceeds a threshold value, and determines a case to be presented based on the enterprise activity information, on the basis of the target subject or the target detailed item and the environmental activity case information.

In a preferred mode of the present invention, the case provision unit receives designation of the subject or the detailed item by designation of the environmental activity case information, and determines the case to be presented based on the designated subject or detailed item.

With such a configuration, regardless of the industry type, any enterprise holds the enterprise activity information having the subject and the detailed item, and its expense. Therefore, even if a user does not sufficiently understand the evaluation index of the environmental management and cannot sufficiently understand the information necessary for the evaluation, the user can efficiently and easily refer to a specific case for dealing with the environmental management.

In a preferred mode of the present invention, the storage unit stores environmental effect measurement information with which a threshold value for determining an environmental effect is associated, and

the case provision unit is configured to be able to determine, as the target subject or the target detailed item, one or a plurality of subjects or detailed items whose totalization result exceeds the threshold value and one or a plurality of subjects or detailed items whose totalization result falls below the threshold value based on the totalization result and the environmental effect measurement information, and to be able to determine the case based on the environmental activity case information for each of the determined target subject or target detailed item.

With such a configuration, it is possible to more accurately provide the specific case for dealing with the environmental management according to the actual situation of enterprise activities.

In a preferred mode of the present invention, the storage unit further stores boundary information indicating whether the subject or the detailed item corresponds or does not correspond to a goal, or a goal and a target with respect to an evaluation index related to SDGs, and stores the environmental activity case information in association with the goal, or the goal and the target in addition to the subject or the detailed item,

the case provision unit receives designation of the goal or the target,

the boundary determination unit determines whether each record of the enterprise activity information corresponds or does not correspond to an evaluation target related to the SDGs based on the boundary information, and

the evaluation unit totalizes the GHG emission amount for each subject or each detailed item corresponding to the designated goal or target, for the record determined to correspond to the evaluation target related to the SDGs, allowing the case provision unit to determine the target subject or the target detailed item.

With such a configuration, even if a user does not sufficiently understand the evaluation index of the environmental management and cannot sufficiently understand the information necessary for the evaluation, the user can efficiently and easily refer to a specific case for dealing with the environmental management related to the SDGs.

In a preferred mode of the present invention, the case provision unit performs display processing at least one of a totalization result of the economic cost and the totalization result of the environmental cost for the goal and the target corresponding to the case and the subject or the detailed item corresponding to the case, in association with the case.

In a preferred mode of the present invention, the enterprise activity evaluation system further includes an analysis unit,

wherein the storage unit stores an alternative detailed item capable of replacing the detailed item, an alternative economic cost that is an amount of money of the alternative detailed item, and an alternative calculation coefficient that is the calculation coefficient corresponding to the alternative detailed item,

the analysis unit retrieves the alternative detailed item for the record of the enterprise activity information, and determines an economic cost and an environmental cost of the alternative detailed item based on the alternative economic cost and the alternative calculation coefficient, and

performs optimization processing including processing of determining the replacing alternative detailed item based on the economic cost and the environmental cost of the detailed item included in the enterprise activity information and the economic cost and the environmental cost of the alternative detailed item such that the totalization result of the environmental cost satisfies a reduction target, and at the same time, the totalization result of the economic cost or alternative points are minimized, and

the case provision unit performs display processing of an economic cost reduction amount and/or an environmental cost reduction amount obtained as a result of the optimization processing for each subject or each detailed item associated with the case, in association with the case.

With such a configuration, it is possible to present meaningful information regarding the case to the user.

### Advantageous Effects of Invention

The present invention can provide a novel technique for improving the efficiency of and simplifying evaluation of enterprise activities dealing with environmental management.

### BRIEF DESCRIPTION OF DRAWINGS

FIG. 1 is a block diagram illustrating a configuration of a system according to one embodiment.

FIG. 2 is a hardware configuration diagram of a system according to one embodiment.

FIG. 3 is a functional block diagram of a system according to one embodiment.

FIG. 4 is a drawing illustrating an example of enterprise activity information in a system according to one embodiment.

FIG. 5 is a drawing illustrating an example of boundary information in a system according to one embodiment.

FIG. 6 is a processing procedure for providing environmental activity cases in a system according to one embodiment.

FIG. 7 is a processing procedure related to correspondence/non-correspondence determination in a system according to one embodiment.

FIG. 8 is a case provision processing procedure in a system according to one embodiment.

FIG. 9 is a screen display example of a case provision screen in a system according to one embodiment.

FIG. 10 is a screen display example of an individual case screen in a system according to one embodiment.

FIG. 11 is a screen display example of a reverse lookup screen in a system according to one embodiment.

FIG. 12 is a processing procedure of optimization processing in a system according to one embodiment.

### DESCRIPTION OF EMBODIMENTS

Hereinafter, the present invention will be described in more detail with reference to the accompanying drawings. A preferred embodiment is illustrated in the drawings. However, the present invention can be implemented in many different embodiments and is not limited to the embodiment described herein.

For example, in the present embodiment, a configuration, an operation, or the like of an enterprise activity evaluation system will be described. However, similar operational effects can be obtained by a method, an apparatus, a computer program, or the like to be executed. In the present embodiment, a so-called server/client type enterprise activity evaluation system in which the program is started in an external computer to enable a client terminal to achieve its functions will be described. The program may be provided as a computer-readable non-transitory recording medium or may be provided in a downloadable manner from an external server.

<1. System Configuration>

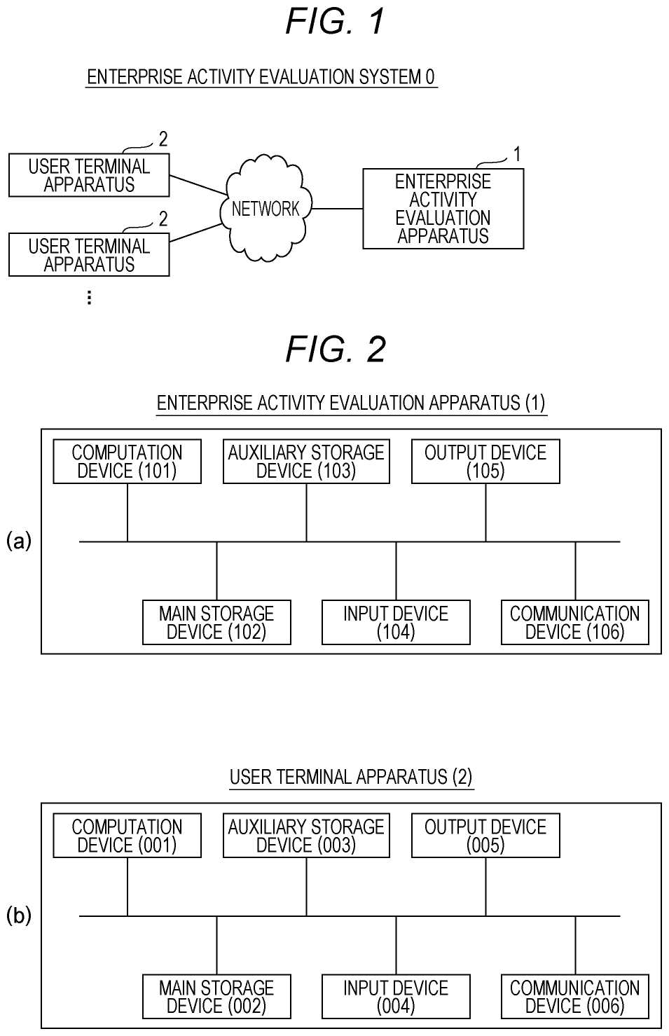

FIG. 1 is a block diagram illustrating a configuration of a system according to one embodiment. As illustrated in FIG. 1, an enterprise activity evaluation system 0 includes an enterprise activity evaluation apparatus 1 (server) and a user terminal apparatus 2 (client). The enterprise activity evaluation apparatus 1 and the user terminal apparatus 2 are configured to be communicable via a communication network NW. The enterprise activity evaluation apparatus 1 operates as a server, and the user terminal apparatus 2 is a smartphone, a personal computer, or the like operated by a user.

As the enterprise activity evaluation apparatus 1, a computer for a general-purpose server, a personal computer, or the like can be used. As the user terminal apparatus 2, a smartphone, a tablet terminal, a personal computer, a wearable device, or the like can be used. The user terminal apparatus 2 has an application (typically, a web browser) for sending a request to and receiving a response from the enterprise activity evaluation apparatus 1.

In the present embodiment, the communication network NW is an internet protocol (IP) network, but the type of its communication protocol is not limited, and the type and scale of the network are also not limited.

<1.1. Hardware Configuration>

FIG. 2 is a hardware configuration diagram. As illustrated in FIG. 2(a), the enterprise activity evaluation apparatus 1 includes a computation device 101, a main storage device 102, an auxiliary storage device 103, an input device 104, an output device 105, a communication device 106, and a bus interface, and is used for exhibiting the action of each unit and each process. At least a part of the hardware configuration of the enterprise activity evaluation apparatus 1 may have a form of SoC or SiP. The enterprise activity evaluation apparatus 1 may further include a customized processor that specializes in predetermined processing such as image processing and machine learning.

The computation device 101 includes a processor such as a CPU capable of executing a command set, and controls the entire operation processing of the enterprise activity evaluation apparatus 1 by running an enterprise activity evaluation program according to the present invention, an OS, browser software, and other applications.

The main storage device 102 includes a volatile memory such as a RAM capable of storing the command set.

The auxiliary storage device 103 includes a non-volatile recording medium, such as an HDD or an SSD, capable of recording the OS and the enterprise activity evaluation program.

The input device 104 includes an input device, such as a keyboard, capable of performing input processing.

The output device 105 includes a display device, such as a display, capable of performing display processing.

The communication device 106 includes an interface to be physically connected to the network, and controls communication with the communication network NW to input and output information.

As illustrated in FIG. 2(b), the user terminal apparatus 2 includes a computation device 001, a main storage device 002, an auxiliary storage device 003, an input device 004, an output device 005, a communication device 006, and a bus interface, and is used for exhibiting the action of each unit and each process.

The computation device 001 includes a processor such as a CPU capable of executing a command set, and runs an OS, a web browser, and other applications.

The main storage device 002 includes a volatile memory such as a RAM capable of storing the command set.

The auxiliary storage device 003 includes a non-volatile recording medium, such as an HDD or an SSD, capable of recording the OS and the web browser application.

The input device 004 includes an input device, such as a keyboard, capable of performing input processing.

The output device 005 includes a display device, such as a display, capable of performing display processing.

The communication device 006 includes an interface to be physically connected to the network, and controls communication with the communication network NW to input and output information.

<1.2. Functional Configuration of Enterprise Activity Evaluation Apparatus>

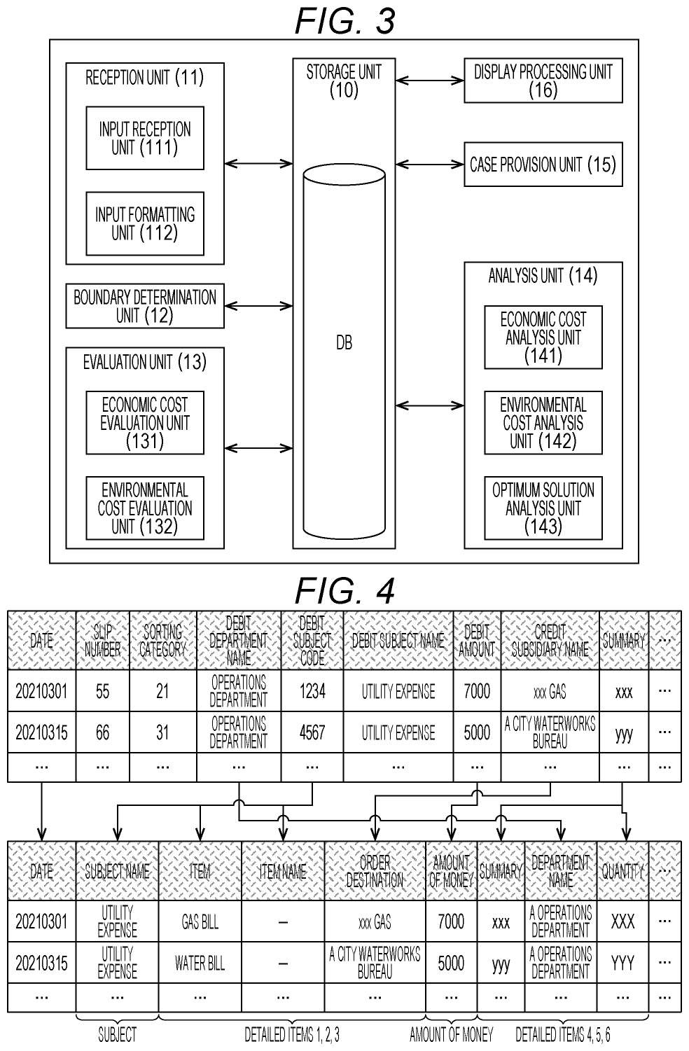

FIG. 3 is a functional block diagram of the enterprise activity evaluation apparatus 1. As illustrated in FIG. 3, the enterprise activity evaluation apparatus 1 includes a storage unit 10, a reception unit 11, a boundary determination unit 12, an evaluation unit 13, an analysis unit 14, a case provision unit 15, a display processing unit 16, and a database DB. Here, information processing by software (stored in the auxiliary storage device 103) is specifically achieved by hardware (the computation device 101 or the like).

Although a configuration in which the enterprise activity evaluation apparatus 1 includes each functional component (unit) is exemplified in the present embodiment, some of the functional components (units) may be included in the user terminal apparatus 2 serving as a client. In addition, the enterprise activity evaluation apparatus may be configured by installing the enterprise activity evaluation program in the user terminal apparatus.

In the present embodiment, the enterprise activity evaluation system 0 is provided to a user in the form of a web application, and is used via the web browser of the user terminal apparatus 2. The display processing unit 16 performs display processing of a provision screen for the user to use the web application, and transmits the display processing result to the user terminal apparatus 2. In addition, the display processing unit 16 receives input (upload) of enterprise activity information and operation input via the provision screen. After processing is executed by the enterprise activity evaluation apparatus 1, the display processing unit 16 transmits the processing result to the user terminal apparatus 2. The following will give the description while omitting the intervention of the display processing unit 16 within a range that is not unclear for description simplicity.

<1.3. Reception Unit>

The reception unit 11 receives the input of the enterprise activity information, and causes the storage unit 10 to store the enterprise activity information used in the subsequent processing. In the present embodiment, the reception unit 11 includes an input reception unit 111 and an input formatting unit 112.

The input reception unit 111 receives the input of the enterprise activity information from the user. In the present embodiment, the input reception unit 111 receives the input of the enterprise activity information having subjects and detailed items, and their expenses via the provision screen. The input formatting unit 112 performs formatting of the enterprise activity information received by the input reception unit 111. The formatting includes processing of converting raw data of the enterprise activity information input by the user into a predetermined data format (common format) to be processed by the enterprise activity evaluation apparatus 1 (e.g., processing of deleting an unnecessary attribute or conversion into a corresponding attribute name), and processing of changing an item name (attribute name) of the input enterprise activity information based on dictionary information or the like, adding an item (attribute), or the like. The formatting may be rule-based processing using a correspondence table or the like, or may be performed by natural language processing, for example.

The enterprise activity information includes accounting information indicating enterprise activities. One element (one record) in the enterprise activity information has a subject, one or a plurality of detailed items, and its expense and quantity. Here, the detailed item(s) has(have) a hierarchical structure including at least a detailed item whose parent is the subject, and a detailed item whose parent is the detailed item. For example, the subject corresponds to an accounting subject, the detailed item whose parent is the accounting subject corresponds to an item, the detailed item whose parent is the item (detailed item) corresponds to an item name, and the detailed item whose parent is the item name (detailed item) corresponds to a summary, a department name, an order destination, and the like.

Furthermore, for example, the detailed item(s) may include a record attribute that is not necessarily in a parent-child relation with the subject or the detailed item(s). For example, the detailed item(s) may include date data indicating a year, a month, a year and month, a date, or the like when the enterprise activity information is generated or registered, data indicating which of direct cost or indirect cost the expense is, data indicating which of variable cost or fixed cost the expense is, department data (department name) where the subject/detailed item(s) is(are) generated, process data that enables specification of the type of work/process corresponding to the record, and traffic line flow data indicating which of a start point, a transit point, and an end point the record belongs to in a purchase (procurement), manufacturing, or sales route. For example, these data may be provided in each record of the enterprise activity information received by the input reception unit 111, or may be added by the input formatting unit 112 on the basis of the subject or the detailed item(s), or the like of the input enterprise activity information. Note that the plurality of detailed items do not necessarily have a hierarchical structure in series, and do not exclude a configuration in which there are a plurality of detailed items whose parent is a common detailed item in one record of the enterprise activity information.

FIG. 4 is a drawing illustrating an example of the input enterprise activity information and the formatted enterprise activity information. Data illustrated in the upper part of FIG. 4 indicates an example of the input enterprise activity information (raw data of the accounting information), and the lower part indicates an example of the formatted enterprise activity information. Note that illustrated subject names or the like may be codes used in the enterprise activity evaluation system 0.

In the present embodiment, the subject and the detailed item(s) of the record are determined on the basis of a subject code (“debit subject code” on the upper side of the illustrated example) included in the input enterprise activity information. This is performed, for example, by storing a subject code of major accounting software or the like, and the subject and the detailed item(s) corresponding to the code, in the storage unit 10 in association with each other. In addition, the subject name (“debit subject name” on the upper side of the illustrated example) in the input enterprise activity information may be subjected to natural language processing to determine the corresponding subject and/or detailed item(s) (e.g., “subject name”, “item”, and “item name” on the lower side of the illustrated example). Alternatively, in addition to the accounting software, output data output from a budget management, purchasing management, production management, or distribution management system, or the like may be used as the enterprise activity information, and formatting corresponding to the format of the output data may be performed.

The input formatting unit 112 may determine an amount of money, a quantity, a unit price, and the like from a sentence included in the summary. This determination may be performed by acquiring a character string or the like adjacent to a specific keyword (e.g., yen, Y, m³, or kWh) included in the summary. For example, information corresponding to the detailed item(s) may be extracted by a rule-based method, a statistical method, machine learning, or natural language processing.

Here, an editing screen on which the enterprise activity information received by the input reception unit 111 and/or the enterprise activity information formatted by the input formatting unit 112 can be edited may be further displayed, and the enterprise activity information subjected to the editing processing on the editing screen may be stored in the database DB of the storage unit 10. At this time, in a case where the enterprise activity information lacks an item, a content, a numerical value, or an amount of money, has a mismatch in quantity, or the like, the input formatting unit 112 may display the portion on the editing screen and receive input.

<1.4. Storage Unit>

The storage unit 10 stores, in the database DB, calculation coefficients, model coefficients, boundary information, activity case information, environmental effect measurement information, information on alternative detailed items, or the like.

<1.5. Evaluation Unit>

The evaluation unit 13 performs cost determination processing and totalization processing as information processing for evaluating the enterprise activity information. In the present embodiment, the evaluation unit 13 includes an economic cost evaluation unit 131 and an environmental cost evaluation unit 132.

The economic cost evaluation unit 131 determines an economic cost indicating the expense for at least some records of the enterprise activity information. In the present embodiment, the expense included in the record or the like as an evaluation target in the enterprise activity information is determined as the economic cost. When the enterprise activity information includes the quantity as the detailed item, and the expense represents the unit price, the economic cost is determined from the quantity and the unit price. In addition, the economic costs included in the enterprise activity information are totalized.

The environmental cost evaluation unit 132 calculates an environmental cost indicating a GHG emission amount of the enterprise activity information on the basis of a coefficient, and associates the environmental cost with each record of the enterprise activity information. In the present embodiment, the environmental cost (CO2 emission amount) of each record is calculated by multiplying the expense by a calculation coefficient or a model coefficient for the record evaluated as the evaluation target (CO2 calculation target) in the enterprise activity information, and the environmental costs included in the records as the evaluation targets in the enterprise activity information are totalized.

The calculation coefficient is, for example, a coefficient set according to the subject or the detailed item(s), and is a coefficient for calculating the CO2 emission amount based on the information (“expense” in the present embodiment) included in the enterprise activity information, such as a unit of Kg-CO2/yen. Note that not only the expense but also a weight, power consumption, or the like may be included in the enterprise activity information. The storage unit 10 may store calculate coefficients whose denominator is the weight, the power consumption, or the like, and the environmental cost evaluation unit 132 may calculate the GHG emission amounts such as CO2 based on the calculation coefficients.

The totalization may be performed for the entire enterprise activity information, or may be performed for each subject or each detailed item. For example, the evaluation unit 13 may perform the totalization of the economic costs and the totalization of the environmental costs for the records having the subject “travel expense and transportation expense”. The totalization may also be performed for the records having a process common to or related to the designated process data (detailed item), the records having a common or related start point, transit point, or end point as the traffic line flow data (detailed item), or the like. In a case where the enterprise activity information has the date data (detailed item), costs during a predetermined period such as one year, or a period designated from the user may be totalized.

Preferably, the calculation coefficients are set on the basis of a greenhouse gas emissions calculation method/emission factor, or the like presented by the Ministry of the Environment or the like. In addition, preferably, the subjects or detailed items where a business operator/order destination can be selected, such as a gas charge, an electricity charge, a water charge, a transportation expense, a material, a component, and a finished product, may be provided with a different calculation coefficient for each business operator/order destination. In the present embodiment, the environmental cost evaluation unit 132 determines the calculation coefficient for calculating the GHG emission amount on the basis of the business operator designated in the detailed item (“order destination” on the lower side of FIG. 4), and calculates the GHG emission amount by multiplying the amount of money included in the record (“amount of money” on the lower side of FIG. 4) by the coefficient.

<1.6. Boundary Determination Unit>

The boundary determination unit 12 determines whether each element included in the enterprise activity information (each record included in the enterprise activity information) corresponds to the evaluation target in performing analysis or the like of an evaluation index of environmental management, on the basis of the boundary information and at least the subject or the detailed item(s) included in the enterprise activity information. Here, the “evaluation index of environmental management” is an existing or unique evaluation index for promoting the environmental management, such as SDGs, GHG emission, calculation of supply chain emissions, a tax system such as a carbon tax, and LCA. The boundary determination unit 12 may determine the record in the enterprise activity information that corresponds to the boundary information by, for example, a rule-based method, a statistical method, machine learning, or natural language processing.

The boundary information is information indicating evaluation target correspondence/non-correspondence criteria listing the subjects or detailed items that correspond to the evaluation target, and the subjects or detailed items that do not correspond to the evaluation target. The boundary information may have information indicating the criteria for each of a plurality of evaluation indexes assumed by the system. In the present embodiment, it is assumed that the criteria as to whether to correspond or not correspond to the evaluation target are provided for a plurality of evaluation indexes related to the SDGs, CO2 calculation (GHG emission), CO2 reduction, the LCA, the calculation of supply chain emissions (Scope 1, 2, Scope 3), and the tax system such as the carbon tax. In addition, for example, the boundary information may further include other criteria such as information for determining whether the detailed item conforms to the green purchasing law.

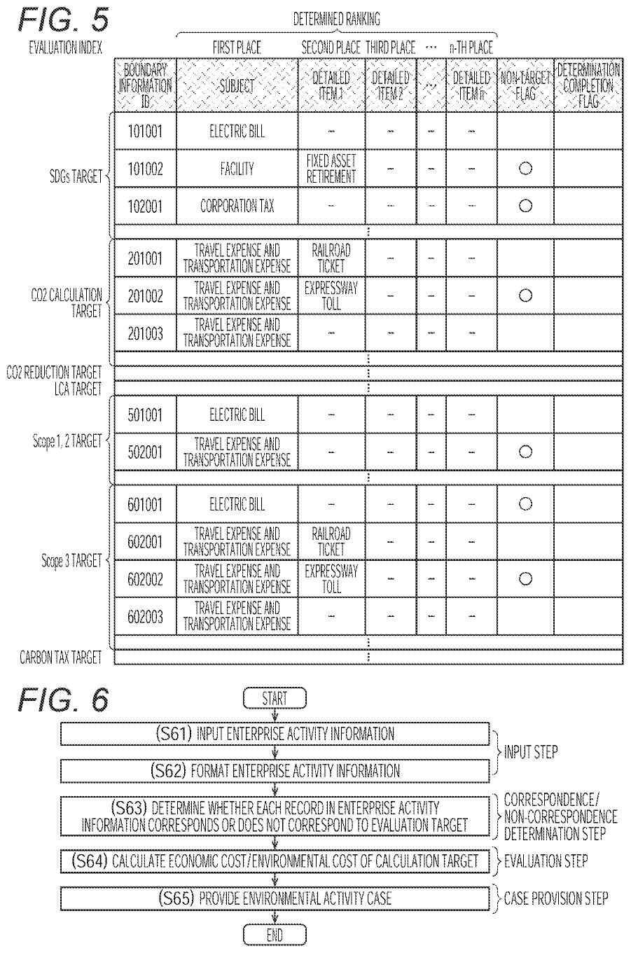

FIG. 5 is a drawing illustrating an example of the boundary information. As illustrated in the illustrated example, the boundary information includes information (“non-target flag” in the illustrated example) indicating whether each subject or each combination of the subject and the detailed item(s) corresponds or does not correspond to the evaluation target for each evaluation index. In addition, the boundary information may include information (“determination completion flag” in the illustrated example) indicating whether determination has been completed when the boundary determination unit 12 determines the correspondence/non-correspondence to the evaluation target for each record included in the enterprise activity information. In a case where there are a plurality of evaluation indexes, the boundary determination unit 12 may perform the correspondence/non-correspondence determination serially or parallelly for each evaluation index.

The boundary information includes not only the subjects or detailed items that correspond to the evaluation target but also the subjects or detailed items that do not correspond to the evaluation target. As a result, it is possible to extract the subject or the detailed item(s) that cannot be concluded to correspond or not correspond only from the information specified in the record of the enterprise activity information and possibly correspond to the evaluation target. For example, suppose that the data whose subject is “travel expense and transportation expense” and detailed items are blank is included in the enterprise activity information. In this case, if the “travel expense and transportation expense” is a train fare or the like, the data corresponds to a GHG emission target, and if the “travel expense and transportation expense” is an expressway toll or the like, the data does not correspond to the GHG emission target. In a case where the record cannot be uniquely specified from the input enterprise activity information, the record having a possibility of being the GHG emission target can be taken into consideration by preparing, as the model coefficient, a coefficient smaller than the calculation coefficient used when the “travel expense and transportation expense” is a train fare.

Furthermore, for example, in a case where the subject is “travel expense and transportation expense”, the detailed item in the second place (detailed item 1) is “business trip expense”, and the subordinate detailed item where the number of staying days is to be input is not yet input, it may become possible to estimate a more realistic GHG emission amount or the like for the record where the number of staying days is unknown by multiplying the average number of staying days (for example, 1 or 2 (days)) as the model coefficient. Note that the model coefficients and the calculation coefficients may be put together in the same table. However, in this case, it is preferable to store the model coefficients and the calculation coefficients in a distinguishable manner.

The corresponding calculation coefficients or model coefficients may be associated with the boundary information used for the boundary determination. For example, an identifier of the boundary information or the subject and/or the detailed item serving as a determination criterion defined in the boundary information may be associated with a master of the calculation coefficient or the model coefficient.

<1.7. Case Provision Unit>

The case provision unit 15 determines environmental activity cases to be presented to the user. The case provision unit 15 may retrieve/determine the cases by, for example, a rule-based method, a statistical method, machine learning, or natural language processing. The cases are stored in the storage unit 10 as the environmental activity case information. The environmental activity case information is information in which the environmental activity case, the subject and/or the detailed item(s) corresponding to the case, and a goal, or a goal and a target in the SDGs are associated with each other. The case has a case No, a case name, a specific case explanatory text, a case title, a case subtitle 1, and a case subtitle 2. Furthermore, an alternative detailed item or an alternative calculation coefficient corresponding to the case may be associated with the environmental activity case information. In addition, a goal, or a goal and a target of the SDGs having a negative influence may be associated with the environmental activity case information.

<2. Procedure of Environmental Activity Evaluation by Boundary Determination>

The enterprise activity evaluation system 0 presents the environmental activity cases to the user based on the input enterprise activity information. FIG. 6 is a processing flowchart for providing the environmental activity cases.

<2.1. Step of Inputting Enterprise Activity Information>

First, the enterprise activity evaluation system 0 executes step S61 and step S62 as input steps. At step S61, the input reception unit 111 receives the input of the enterprise activity information from the user. At step S62, the input formatting unit 112 formats the received enterprise activity information and generates the enterprise activity information formatted into the common format. When the enterprise activity information input at step S61 is already data conforming to the common format, step S62 is unnecessary.

<2.2. Correspondence/Non-Correspondence Determination Step>

Next, the enterprise activity evaluation system 0 executes step S63 as a correspondence/non-correspondence determination step. At step S63, the boundary determination unit 12 determines whether each record included in the enterprise activity information in the common format corresponds or does not correspond to the evaluation target according to the boundary information on the basis of the subject or the detailed item(s) and the boundary information. The record of the enterprise activity information determined to correspond is information having the subject or the detailed item(s) where the GHG emission amount can be calculated using one calculation coefficient, and the record of the enterprise activity information determined not to correspond is information having the subject or the detailed item(s) that do not correspond to a calculation target.

Here, the boundary determination unit 12 further adds the model coefficient to the record having the subject or the detailed item(s) that does not fall under either of the correspondence/non-correspondence. The record that does not fall under either of the correspondence/non-correspondence is the record having the subject or the detailed item(s) to which a plurality of calculation coefficients possibly correspond, or the record having the subject or the detailed item(s) to which one or a plurality of calculation coefficients possibly correspond and that possibly does not correspond to the calculation target. Typically, it refers to the record that cannot be determined that the GHG emission amount can be calculated using one calculation coefficient or that the information does not correspond to the calculation target due to the lack of the detailed item or the nature of information such as accounting information or the like to be incorporated as the enterprise activity information.

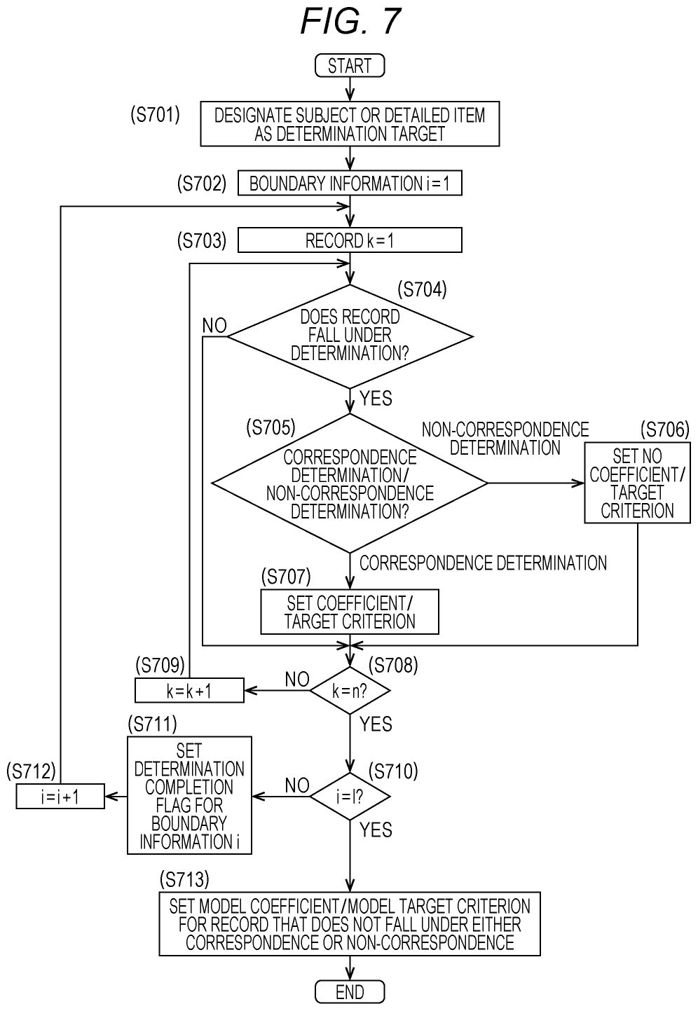

The boundary determination unit 12 determines the model coefficient to be added to the record having the subject or the detailed item(s) that does not fall under either of the correspondence/non-correspondence on the basis of the evaluation index and one or more of the associated subject and detailed item(s). In the present embodiment, by performing the correspondence/non-correspondence determination according to the boundary information illustrated in FIG. 5, the table of the model coefficients and the calculation coefficients, which is not illustrated, and a processing flowchart illustrated in FIG. 7, the calculation coefficient can be added to the record determined to correspond, and the model coefficient, or the model coefficient and the calculation coefficient can be added to the record that does not fall under either of the correspondence/non-correspondence.

<2.3. Processing Procedure for Determining Correspondence/Non-Correspondence>

FIG. 7 illustrates a procedure for determining the correspondence/non-correspondence of a record k (1, 2, . . . , n) included in the enterprise activity information using boundary information i (1, 2, . . . , l) for a certain determination criterion. At this time, the boundary information i will be described as performing the correspondence/non-correspondence determination in order from the top of the hierarchical structure of the subject and the detailed item(s) (from the defined subject or in ascending order of the subject and the detailed item(s)) for at least each subject, that is, in ascending order of the determined ranking for at least each subject as illustrated in FIG. 4. The correspondence/non-correspondence determination/coefficient addition procedure and the structure of the boundary information are not limited to the present example.

At step S701, the enterprise activity information is input via the reception unit 11, and the subject or the detailed item as a determination target is set. Here, in one example, some or all of the items of the input enterprise activity information may be duplicated in a format having a coefficient item or a target criterion item in a new table of the database DB or the like. At step S702, boundary information 1, which is the first boundary information used for the correspondence/non-correspondence determination, is set for the subject or the detailed item set at step S701. In addition, at step S703, record 1, which is the first record in the enterprise activity information determined using the boundary information 1, is set.

For example, the subject or the detailed item set at step S701 is the subject or the detailed item corresponding to the parent or higher of the boundary information determined subsequently, and is the subject or the detailed item that cannot be independently determined to correspond or not correspond. For example, for the boundary information on the CO2 calculation target in FIG. 4, the subject “travel expense and transportation expense” is set as the determination target at step S701. The boundary information set at step S702 is, for example, the boundary information in which the subject corresponding to the children of the “travel expense and transportation expense” set at step S701 is “travel expense and transportation expense” and the detailed item is “railroad ticket”.

At step S704, the subject, or the subject and the detailed item(s) defined in the boundary information 1 are compared with some or all of the subject, or the subject and the detailed item(s) included in the record 1. In a case where the record 1 matches the subject, or the subject and the detailed item(s) defined in the boundary information 1, the process proceeds to step S705.

In a case of the correspondence determination at step S705, that is, in a case where the record 1 includes the subject, or the subject and the detailed item(s) defined in the boundary information 1, and where the boundary information 1 does not have the non-target flag, a coefficient is set or a target criterion is set for the record 1. The setting refers to processing of adding the coefficient or the target criterion.

Here, in a case where the determination criterion is the SDGs, the target criterion may be the goal, or the goal and the target, or may be information indicating whether or not to correspond to the determination criterion. In a case where the determination criterion is the supply chain emissions, the target criterion may be Scopes 1 to 3, or may be information indicating whether or not to correspond to the determination criterion. Note that when Scopes 1 to 3 are added as the target criterion, the process data, the traffic line flow data, or the like as the detailed item may be set in the boundary information.

In a case of the non-correspondence determination at step S705, that is, in a case where the record 1 includes the subject, or the subject and the detailed item(s) defined in the boundary information 1 and the boundary information 1 has the non-target flag, the coefficient is not set or the target criterion is not set for the record 1. The non-setting refers to processing of not adding the coefficient or the target criterion.

In a case of not falling at step S704, that is, in a case where the record 1 does not fall under either of the correspondence/non-correspondence, or in a case where the record 1 corresponds to either of the correspondence/non-correspondence at step S705, and the coefficient or the target criterion is set or not set, the process proceeds to step S708. In a case where the determination has not been completed for all the records (NO at step S708), the next record k+1 is set at step S709, and the processing from step S705 to step S708 is repeated until the determination is completed for all the records. In a case where the processing has been completed for all the records (YES at step S708), the process proceeds to step S710.

In a case where the determination has not been completed for all the pieces of boundary information related to the subject or the detailed item set at step S701 (NO at step S710), the determination completion flag is set for the boundary information 1 at step S711, and the process proceeds to step S712. At step S712, the next boundary information i+1 (for example, in the case of FIG. 4, the boundary information in which the subject is “travel expense and transportation expense” and the detailed item is “expressway toll”) is set, and the processing from step S705 to S710 is repeated until the determination is completed for all the pieces of boundary information. In a case where the processing has been completed for all the pieces of boundary information (YES at step S710), the process proceeds to step S713, and the model coefficient is added to the record that does not fall under either of the correspondence/non-correspondence.

The processing from step S701 to step S713 is repeated for each subject or each detailed item set at S701, and the processing is executed for all the pieces of boundary information, to perform the correspondence/non-correspondence determination for the enterprise activity information and the addition of the model coefficient to the record that does not fall under either of the correspondence/non-correspondence. Note that step S713 may be configured such that the model coefficient is multiplied after totalizing the multiplication destinations of the coefficient such as the amount of money of the record that does not fall under either of the correspondence/non-correspondence.

In the present embodiment, first, the boundary information is selected, the determination of each record is performed for the boundary information, and then the next boundary information is selected. However, first, the record may be selected, the determination of each boundary information may be performed for the subject, or the subject and the detailed item(s) included in the record, and then the next record may be selected. This processing may be performed serially or parallelly for each boundary information/record, and the determination may be processed serially or parallelly for each determination criterion.

The evaluation unit 13 further determines whether each record of the enterprise activity information corresponds or does not correspond to an evaluation target regarding the SDGs according to the boundary information. According to the procedure of FIG. 7, the goal, or the goal and the target of the SDGs, or the information indicating the target/non-target is set/not set as the target criterion, to perform the determination of the correspondence/non-correspondence to the evaluation target for the enterprise activity information.

<2.4. Evaluation Step>

At step S64, the evaluation unit 13 determines the economic cost for each record, and determines the environmental cost indicating the GHG emission amount for each record determined to correspond to the evaluation target of the GHG calculation. For the record where the model coefficient is set, the environmental cost is determined based on the model coefficient. In the present embodiment, since the calculation coefficient or the model coefficient is added to the record, the evaluation unit 13 determines the GHG emission amount on the basis of the coefficient set for each record at step S63 and the expense, and stores the GHG emission amount in association with each record of the enterprise activity information. In one example, some or all of the items of the enterprise activity information are duplicated in a new table of the database DB or the like, and the determined environmental cost is added to an environmental cost item.

Furthermore, the evaluation unit 13 totalizes the economic costs and the environmental costs in the enterprise activity information for each subject or each detailed item. The totalization for each subject or each detailed item may be performed, for example, for each subject or each detailed item included in the input enterprise activity information (or obtained after formatting), or for each subject or each detailed item designated by the user. A method of designating the subject or the detailed item will be described below.

<2.5. Case Provision Step>

At step S65, the case provision unit 15 determines the environmental activity cases on the basis of the totalization results at step S64, and provides the cases to the user.

<3. Case Provision Processing Procedure>

<3.1. Common Procedure>

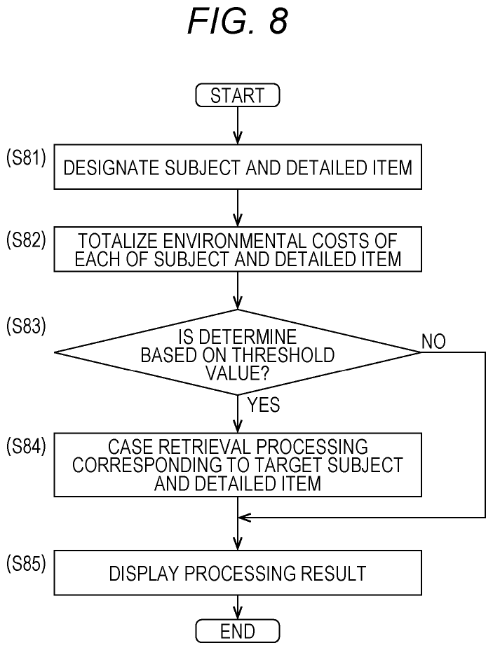

Next, a case provision processing procedure will be described with reference to FIG. 8.

At step S81, the case provision unit 15 receives the designation of the subject or the detailed item for retrieving the cases. At step S82, the environmental cost evaluation unit 132 totalizes the environmental costs that are the GHG emission amounts for each subject or each detailed item in the records of the enterprise activity information having the subject or the detailed item designated at step S81. Note that the totalization may be performed for each subject and for each subject and detailed item. The detailed item used as the basis of totalization is optionally set, and is, for example, the detailed item indicating the item, and for example, the detailed item indicating the item name is used as the basis of totalization. For example, the totalization of each subject, each item, or each item name may be performed for each detailed item such as the traffic line flow data, the process data, or the date data.

At this time, the economic cost evaluation unit 131 also totalizes the economic costs that are the expenses, for each subject or each detailed item with respect to the records of the enterprise activity information having the subject or the detailed item designated at step S81.

At step S83, the case provision unit 15 determines the totalized environmental cost on the basis of a threshold value. In the present embodiment, first, determination based on a first threshold value is performed. Here, the first threshold value is used to determine whether or not the totalized environmental cost is small, and the case provision unit 15 excludes the subject or the detailed item having a small environmental cost from the case presenting target. The first threshold value is, for example, a predetermined environmental cost, and different environmental costs may be set for some or all of the subjects or the detailed items.

The case provision unit 15 determines the subject or the detailed item where the corresponding totalization result exceeds the threshold value as a target subject or a target detailed item (YES at step S83). At step S84, the environmental activity case information with which the target subject or the target detailed item is associated is retrieved. At step S85, the retrieved cases are displayed to the user.

<3.2. Case Provision Screen>

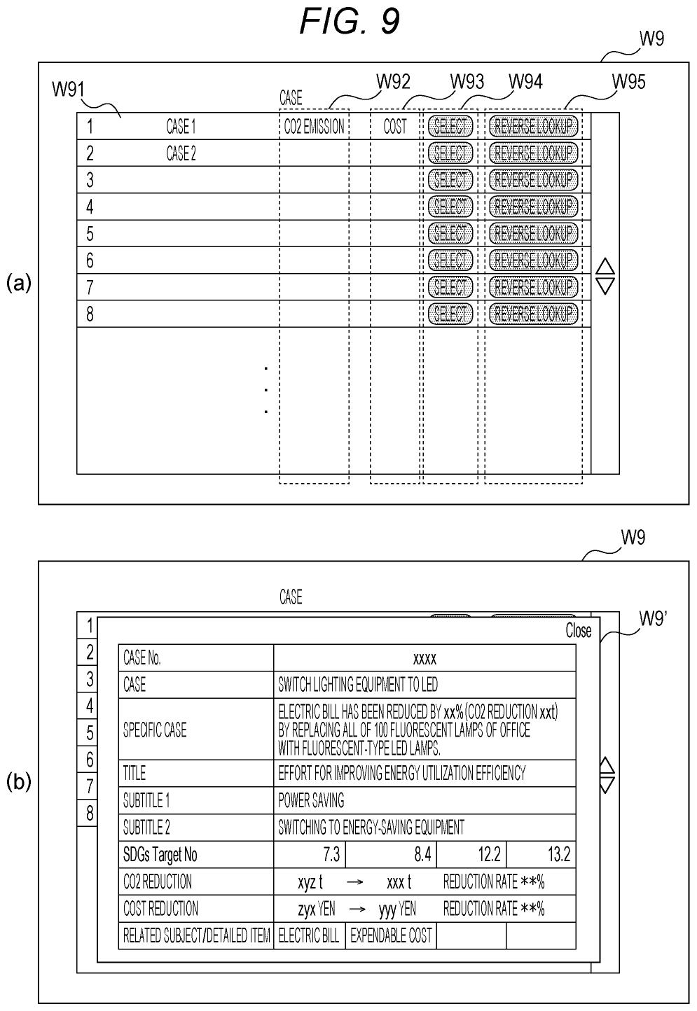

FIG. 9 is a screen display example of a case provision screen. When the case provision unit 15 determines the cases to be provided on the basis of the target subject or the target detailed item, the display processing unit 16 performs display processing of the case provision screen. As illustrated in FIG. 9 (a), a case provision screen W9 includes a case display area W91, an environmental cost display area W92, an economic cost display area W93, a case selection button W94, and a reverse lookup button W95.

The case display area W91 displays the title of the case on the basis of the environmental activity case information determined by the case provision unit 15. The environmental cost display area W92 displays the GHG emission amount (in the illustrated example, “CO2 emission”) for the subject or the detailed item associated with the case. Similarly, the economic cost display area W93 displays the economic cost (in the illustrated example, “cost”) for the subject or the detailed item associated with the case. Note that the case provision unit 15 may display, in association with the case, at least one of the totalization results of the economic cost and the environmental cost for the goal and the target corresponding to the case and the subject or the detailed item corresponding to the case. The case display area W91 may display the goal, or the goal and the target associated with the environmental activity case information.

When the reverse lookup button W95 is pushed, reverse lookup described later is performed. When the case selection button W94 is pushed, the display processing unit 16 displays an individual case screen W9′ illustrated in FIG. 9(b) for the selected case.

FIG. 9(b) is a screen display example of the individual case screen W9′. The individual case screen W9′ is a screen displaying the information included in the environmental activity case information. The individual case screen W9′ may display the case No., the specific case, the title, the goal, the target, the subject, the detailed item(s), and the like included in the environmental activity case information.

<3.3. Presentation of Reduction Amount>

The analysis unit 14 is used for information processing for calculating a cost reduction amount of the enterprise activity information. The analysis unit 14 includes an economic cost analysis unit 141 used for determining information indicating an economic cost reduction amount and an environmental cost analysis unit 142 used for determining information indicating an environmental cost reduction amount.

The individual case screen W9′ may display information indicating a reduction amount when the case is adopted, for each case. The information indicating the reduction amount is, for example, costs before and after reduction and/or a reduction rate, a cost reduction amount, or the like.

The analysis unit 14 may determine the information indicating the reduction amount according to the detailed item associated with the case and the alternative detailed item corresponding thereto. Alternatively, the analysis unit 14 may determine the information indicating the reduction amount according to a reduction coefficient. The analysis unit 14 may determine the alternative detailed item corresponding to the record in the enterprise activity information by, for example, a rule-based method, a statistical method, machine learning, or natural language processing.

The alternative detailed item is, for example, a product/service having a different item name, or is a product/service provided from a different provider, and is associated with information for calculating an alternative economic cost and an alternative environmental cost. The information for calculation is, for example, the calculation coefficient (alternative calculation coefficient) for calculating the economic cost or the environmental cost in a case where the detailed item is replaced with the alternative detailed item on the basis of the detailed item (e.g., quantity or unit price), the environmental cost, the economic cost, and the like associated with the record before replacement. For example, the alternative detailed item regarding an electricity charge includes an electric bill as the subject and an order destination as the detailed item, and stores the calculation coefficient (alternative calculation coefficient) for calculating the alternative environmental cost, and a charge or a charge unit price (alternative economic cost) of the alternative detailed item in association with each other. Note that the calculation coefficient regarding the electricity charge is preferably based on, for example, a list of emission factors by electric power utility announced by the Ministry of the Environment. Note that the alternative detailed item may be divided into an alternative detailed item table listing the alternative detailed items directed to economic cost reduction and an alternative detailed item table listing the alternative detailed items directed to environmental cost reduction, and both of the tables may include different alternative detailed items (item names or order destinations) for a common subject or detailed item (item or item name).

Furthermore, information indicating fluctuation in the economic cost and/or the environmental cost caused in connection with adopting the alternative detailed item may be associated with the alternative detailed item. The information indicating the cost fluctuation related to the alternative detailed item is, for example, the calculation coefficient (related calculation coefficient) capable of calculating the economic cost or the environmental cost that fluctuates in connection with a case where the detailed item is replaced with the alternative detailed item on the basis of the detailed item (e.g., quantity or unit price), the environmental cost, the economic cost, and the like associated with the record before replacement.

For example, in a case where the record having an order destination (electric power company) as the detailed item and an electric bill as the subject concerning electricity by thermal power generation or the like is replaced with the alternative detailed item such as private solar power generation or private biomass power generation, the GHG emission amount (environmental cost) is reduced from the viewpoint of a power generation method, whereas the GHG emission amount (environmental cost) may increase from another viewpoint such as deforestation accompanying building of a power generation facility. In addition, with regard to the economic cost, fixed asset depreciation or equipment management cost, and the like increase. The related calculation coefficient at this time is, for example, a coefficient multiplied by the amount of money, or the amount of money and the unit price, the quantity (kWh), or the like associated with the detailed item before replacement to calculate the amount of increase (m³) in the GHG emission amount, and thus, it is possible to calculate the fluctuation in the environmental cost caused in connection with adopting the alternative detailed item.

Furthermore, the subject or the detailed item to which the cost fluctuation is related may be associated with the related calculation coefficient. In the example described above, in a case where the electricity is replaced with the private solar power generation, an increase in the economic cost such as the depreciation or maintenance cost of the solar power generation facility can be cited as the cost fluctuation caused in connection therewith. The economic cost is associated with the subject “fixed asset” and the detailed item “maintenance cost”, and the subject or the detailed item such as “fixed asset” and “maintenance cost” may be associated with the related calculation coefficient.

The association between the alternative detailed item and the cost fluctuation related thereto may be provided with the related calculation coefficient and the subject or the detailed item for each alternative detailed item. Alternatively, as a related detailed item stored so as to be referable from an ID assigned to the alternative detailed item when the alternative detailed item is selected, or stored so as to be referable from the subject or the detailed item of the alternative detailed item, the coefficient indicating the fluctuation in the economic cost and the environmental cost, and the subject or the detailed item related thereto may be associated with each other. For example, as the related detailed item information, the ID of the related detailed item, the ID of the associated alternative detailed item, the subject or the detailed item of the related detailed item, and the related calculation coefficient of the economic cost and/or the environmental cost may be stored in the database DB in association with each other.

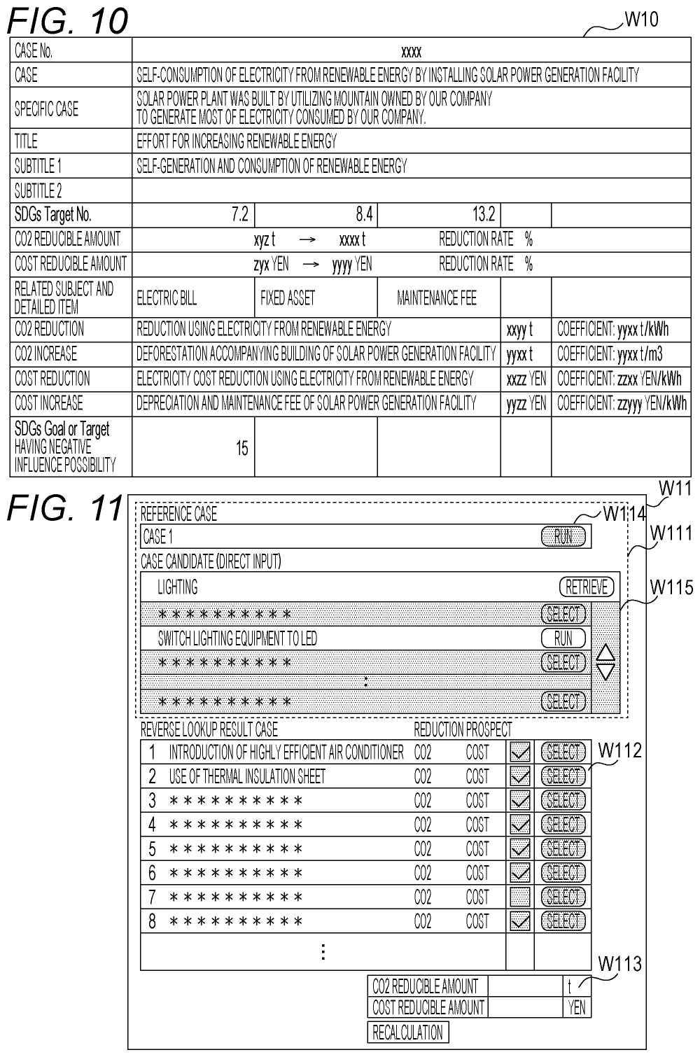

FIG. 10 is a screen display example of an individual case screen in a case of displaying the related detailed item. An individual case screen W10 is a screen displaying the information included in the environmental activity case information. The individual case screen W10 displays the case No., the specific case, the title (title, subtitle 1), the goal, the target, the related subject or detailed item, and the like included in the environmental activity case information, and further displays the goal, or the goal and the target of the SDGs having a negative influence associated with the environmental activity case information. This negative influence can be considered as a case corresponding to the related detailed item related to the alternative detailed item having a positive influence. The related subject or detailed item is the subject or the detailed item associated with the alternative detailed item, and the subject or the detailed item associated with the related detailed item.

Here, for the alternative detailed item and the related detailed item associated with the case, the reduction amount, the amount of money, and the reduction rate of the economic cost and/or the environmental cost, and an increase amount, an amount of money, and an increase rate of the economic cost and/or the environmental cost may be further displayed side by side. The evaluation unit 13 calculates the economic cost and/or the environmental cost increase/reduction amount based on the alternative calculation coefficient and the related calculation coefficient associated with the alternative detailed item and the related detailed item. The display processing unit 16 may add the economic cost and/or the environmental cost increase/reduction amount calculated by the evaluation unit 13 to the individual case screen, or instead, display the economic cost and/or the environmental cost increase/reduction amount in the case display area of the case provision screen for each case.

In a case where the information indicating the reduction amount is obtained based on the alternative detailed item, the economic cost analysis unit 141 or the environmental cost analysis unit 142 retrieves an optional alternative detailed item that replaces the record having the subject or the detailed item(s) corresponding to the case, and the economic cost evaluation unit 131 or the environmental cost evaluation unit 132 determines the information indicating the cost reduction amount by using the alternative economic cost of the retrieved alternative detailed item and the alternative environmental cost calculated based on the alternative calculation coefficient. At this time, in a case where the related detailed item exists, the information indicating the cost reduction amount (or increase amount) is determined by calculating the economic cost and/or the environmental cost for the related detailed item as well.

Note that the information indicating the cost reduction amount may be obtained on the basis of the alternative detailed item adopted by optimization processing described later. In a case where the information indicating the cost reduction amount is determined as a result of the optimization processing described later, the case provision unit 15 may not present, to the user, the case to which the alternative detailed item not adopted as the result of the optimization processing is related.

In a case where the information indicating the reduction amount is obtained on the basis of the reduction coefficient, the analysis unit 14 determines the information indicating the reduction amount by multiplying the cost before application of the case by the reduction coefficient that defines the reduction amount by application of the case in advance. The cost before application of the case is the economic cost and the environmental cost totalized by the evaluation unit 13 based on the subject or the detailed item associated with the case. The reduction coefficient is a coefficient for calculating the amount of change in the economic cost/the environmental cost assumed when the case is applied by multiplying the case and the totalization result before application, and is preferably set for each of the economic cost and the environmental cost for each subject or each detailed item in each case.

<3.4. Forward Lookup>

In the present embodiment, the enterprise activity evaluation system 0 provides the cases in a forward lookup manner as a case providing method. In the case of forward lookup, the designation of the subject or the detailed item at step S81 is performed on the basis of the subjects or the detailed items included in the input enterprise activity information. At this time, the environmental cost evaluation unit 132 may totalize the GHG emission amounts for each subject or each detailed item included in the enterprise activity information, and the case provision unit 15 may present the cases on the basis of the environmental activity case information with which the target subject or the target detailed item exceeding the threshold value is associated.

<3.5. Optional Subject and Detailed Item Designation>

The designation of the subject or the detailed item at step S81 may be performed for each subject or each detailed item optionally designated by the user. At this time, the case provision unit 15 may receive the subject or the detailed item optionally selected by the user, the environmental cost evaluation unit 132 may totalize the GHG emission amounts for each received subject or detailed item, and the case provision unit 15 may present the cases on the basis of the environmental activity case information with which the target subject or the target detailed item exceeding the threshold value is associated.

Alternatively, the user may designate the goal or the target of the SDGs. At this time, the evaluation unit 13 may totalize the GHG emission amounts for each subject or each detailed item corresponding to the designated goal or target for the records determined to correspond to the evaluation target by the boundary determination unit 12, so that the case provision unit may determine the target subject or the target detailed item.

<3.6. Case Determination Based on Environmental Effect Measurement Information>

Here, the reception unit 11 or the case provision unit 15 may further receive input of an enterprise attribute of an enterprise that has input the enterprise activity information. The enterprise attribute may be one or a plurality of enterprise attributes such as the industry type of the enterprise, a listing market, a listed item, capital, and the number of employees.

The case provision unit 15 may determine the target subject or the target detailed item on the basis of the environmental effect measurement information. The environmental effect measurement information is the threshold value (second threshold value) used for the determination at S83, and indicates a GHG emission amount value that can be considered as dealing with the environmental management. More specifically, for example, the environmental effect measurement information is an industry average value of the GHG emission amount such as the CO2 emission amount. When the environmental effect measurement information is below the industry average value, it may be considered that the enterprise is dealing with the environmental management. As the threshold value, a plurality of threshold values may be set for each subject or each detailed item, and a plurality of threshold values may be set according to the enterprise attribute(s).

The environmental cost evaluation unit 132 totalizes the GHG emission amounts for each subject or each detailed item included in the enterprise activity information (designated on the basis of the input enterprise activity information), and the case provision unit 15 determines one or a plurality of subjects or detailed items whose totalization result(s) exceed(s) the threshold value (second threshold value) and one or a plurality of subjects or detailed items whose totalization result(s) fall(s) below the threshold value (second threshold value) as the target subject(s) or the target detailed item(s) on the basis of the totalization results and the environmental effect measurement information. The second threshold value for comparison corresponds to the totalized subject or detailed item, and is preferably selected according to the enterprise attribute.

Here, the subject(s) or the detailed item(s) below the second threshold value and the subject(s) or the detailed item(s) above the second threshold value are determined as the target subject(s) or the target detailed item(s). Preferably, the case provision unit 15 selects the target subject(s) or the target detailed item(s) from among the subjects or the detailed items below the second threshold value and/or the subjects or the detailed items above the second threshold value on the basis of the second threshold value to obtain the target subject(s) or the target detailed item(s).

Specifically, among the subjects or the detailed items below/above the second threshold value, one or a plurality of subjects or detailed items close to the second threshold value are determined as the target subject(s) or the target detailed item(s). Alternatively, the second threshold value is multiplied by a band included in the evaluation target or a coefficient (for example, 1.2 or 0.8), and the subject(s) or the detailed item(s) falling below the second threshold value and not falling below the second threshold value multiplied by the coefficient, and the subject(s) or the detailed item(s) exceeding the second threshold value and not exceeding the second threshold value multiplied by the coefficient (the subject(s) or the detailed item(s) included in the band) may be obtained as the target subject(s) or the target detailed item(s).

The case provision unit 15 is configured to be able to determine the cases on the basis of the environmental activity case information, for each of the one or the plurality of target subjects or target detailed items whose totalization result(s) exceed(s) the threshold value and the one or the plurality of target subjects or target detailed items whose totalization result(s) fall(s) below the threshold value.

<3.7. Reverse Lookup>

In the present embodiment, the enterprise activity evaluation system 0 can provide the cases in a reverse lookup manner as the case providing method. In the case of reverse lookup, the designation of the subject or the detailed item at step S81 is performed on the basis of the subject or the detailed item associated with the environmental activity case information designated by the user. At this time, the environmental cost evaluation unit 132 may totalize the GHG emission amounts for each subject or each detailed item associated with the environmental activity case information, and the case provision unit 15 may present the cases on the basis of the environmental activity case information with which the target subject or the target detailed item exceeding the first threshold value is associated, and that is different from at least the designated environmental activity case information.

<3.8. Reverse Lookup Screen>

FIG. 11 is a screen display example of a reverse lookup screen. When receiving a display processing request from the user, the display processing unit 16 performs display processing of a reverse lookup screen W11. The display processing request means, for example, that the reverse lookup button W95 is pushed on the case provision screen W9. Note that some or all of the elements in the case provision screen and some or all of the elements in the reverse lookup screen may be arranged in the same screen.

As illustrated in FIG. 11, the reverse lookup screen W11 includes a case designation area W111, a reverse lookup case display area W112, and a reduction cost display area W113. The case designation area W111 includes a forward lookup case designation area W114 for designating the case designated in the case provision screen, and a case retrieval area W115 for retrieving the environmental activity case information stored in the database DB and enabling designation of the retrieval result. When the user transmits a retrieval query via the case retrieval area W115, the case provision unit 15 performs the retrieval processing of the environmental activity case information, and the display processing unit 16 displays the processing result. When the user selects the retrieved environmental activity case information, the case provision unit 15 receives the subject or the detailed item for retrieving the cases by reverse lookup. Note that in the case retrieval area W115, a case not completely matching the retrieval query may also be retrievable using, for example, a synonym engine based on a word vector or the like, or natural language processing.

The reverse lookup case display area W112 displays a list of the cases retrieved by the case provision unit 15 on the basis of the subject or the detailed item designated by selecting the case. The reverse lookup case display area W112 may display the reduction amounts of the economic cost and the environmental cost caused by implementing the case, for each case. Note that the reduction amounts of the economic cost and the environmental cost may include a case where at least one of the costs increases (the reduction amount is negative). Furthermore, the cases listed in the reverse lookup case display area W112 are configured to be selectable, and the case provision unit 15 displays the total of the reduction amounts of the economic costs and the environmental costs of the cases selected here, in the reduction cost display area W113. The display processing unit 16 may display the economic cost and/or the environmental cost increase and reduction amounts calculated by the evaluation unit 13 in the reverse lookup case display area, for each case.

<4. Use of Optimization Processing>

<4.1. Optimization Processing by Analysis Unit>

Here, the information indicating the reduction amounts of the economic cost and the environmental cost presented at the time of forward lookup or reverse lookup may be given as a result of the optimization processing by the analysis unit 14. In the present embodiment, the analysis unit 14 further includes an optimum solution analysis unit 143. The optimum solution analysis unit 143 performs the optimization processing on the enterprise activity information.

<4.2. Optimum Solution Analysis Unit>

The optimum solution analysis unit 143 performs the optimization processing of the detailed item on the basis of the economic cost and the environmental cost of the record included in the enterprise activity information and the economic cost and the environmental cost of the corresponding alternative detailed item record.

The optimum solution analysis unit 143 determines whether or not each alternative detailed item is set as a candidate for adoption on the basis of the economic cost and the environmental cost of the alternative detailed item. For example, the alternative candidate is determined to be adopted in a case where the economic cost reduction amount and the environmental cost reduction amount are calculated from the economic cost and the environmental cost of the alternative detailed item and the economic cost and the environmental cost of the record before being replaced, and the economic cost reduction amount and/or the environmental cost reduction amount are/is reduced when the two amounts are multiplied by a predetermined coefficient, and the units thereof are matched such that the two amounts can be compared for magnitude, or the two amounts are made into dimensionless quantities (converted into points) and added together.

For example, in a case where both of the economic cost and the environmental cost are reduced, or in a case where the environmental cost is reduced and the economic cost is not changed, the optimum solution analysis unit 143 determines that the alternative candidate is to be adopted. In a case where the environmental cost is slightly reduced, but the economic cost greatly increases, and the result of adding the two points indicates a cost increase, the optimum solution analysis unit 143 determines that the alternative candidate is not to be adopted.

<4.3. Processing Procedure of Optimization Processing>

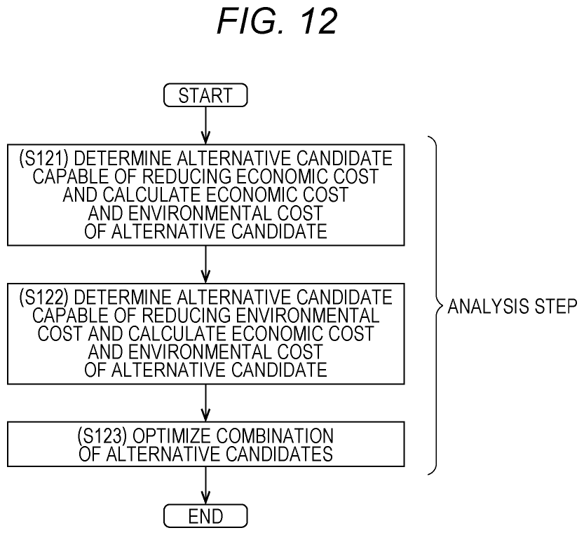

FIG. 12 is a processing flowchart illustrating a processing procedure of the optimization processing. At step S121, the economic cost analysis unit 141 searches the alternative detailed item table for economic cost reduction for each record of the enterprise activity information, and stores the retrieved alternative detailed item in an alternative detailed item list. The economic cost evaluation unit 131 determines the economic cost of the alternative detailed item based on the alternative economic cost associated with the alternative detailed item, and the environmental cost evaluation unit 132 calculates the environmental cost of the alternative detailed item based on the alternative calculation coefficient associated with the alternative detailed item retrieved from the alternative detailed item table for economic cost reduction.

Similarly, at step S122, the environmental cost analysis unit 142 searches the alternative detailed item table for environmental cost reduction for each record of the enterprise activity information, and stores the retrieved alternative detailed item in an alternative detailed item list. The environmental cost evaluation unit 132 determines the environmental cost of the alternative detailed item based on the alternative environmental cost associated with the alternative detailed item, and the economic cost evaluation unit 131 calculates the economic cost associated with the alternative detailed item retrieved from the alternative detailed item table for environmental cost reduction. If the alternative detailed item has the related detailed item, the cost calculation may be performed for the related detailed item as well. The optimum solution analysis unit 143 determines whether or not each alternative detailed item is set as the candidate for adoption on the basis of the economic cost and the environmental cost of the alternative detailed item.

At step S123, the optimum solution analysis unit 143 performs the optimization processing by optimizing a combination of the alternative detailed items that have been set as the candidates for adoption. The optimum solution analysis unit 143 executes the optimization processing by providing an optional objective function and an optional determination criterion. In the present embodiment, the optimization processing is executed by performing a trial calculation of the adopted combination of the alternative detailed items as the candidates for adoption such that the totalization result of the environmental cost of the enterprise activity information when the alternative detailed item is adopted satisfies a reduction target, and at the same time, the totalization result of the economic cost, or alternative points are minimized.

The case provision unit 15 performs display processing the economic cost reduction amount and/or the environmental cost reduction amount obtained as the result of the optimization processing in association with the case on the basis of the subject or the detailed item associated with the case. The economic cost reduction amount and/or the environmental cost reduction amount obtained as the result of the optimization processing are/is totalized by the evaluation unit 13 on the basis of the subject or the detailed item associated with each case.

Note that the economic cost analysis unit 141 and the environmental cost analysis unit 142 may present a proposed change for the subject or the detailed item by, for example, unifying and diversifying a purchase and sales route, or changing a transportation route at the time of purchase/sales, in addition to replacing the record included in the enterprise activity information with the alternative detailed item. This means that the unit price is unified to an order destination providing a low unit price when the records including the same item (detailed item) or the same item name (detailed item) and having different order destinations (detailed item) are included in the enterprise activity information. At this time, the cost may be multiplied by a reduction coefficient set for each of the unification and diversification of the purchase and sales route and the change of the transportation route at the time of purchase and sales to determine the information indicating the reduction amount.

### REFERENCE SIGNS LIST

0 Enterprise activity evaluation system
1 Enterprise activity evaluation apparatus
2 User terminal apparatus
10 Storage unit
11 Reception unit
111 Input reception unit
112 Input formatting unit
12 Boundary determination unit
13 Evaluation unit
131 Economic cost evaluation unit
132 Environmental cost evaluation unit
14 Analysis unit
141 Economic cost analysis unit
142 Environmental cost analysis unit
143 Optimum solution analysis unit
15 Case provision unit
16 Display processing unit
NW Communication network

1. An enterprise activity evaluation system for enterprise activities dealing with environmental management,
the enterprise activity evaluation system comprising: a reception unit; a storage unit; a boundary determination unit; and an evaluation unit,
wherein the reception unit receives input of enterprise activity information including a subject and a detailed item, and its expense,
the detailed item having a hierarchical structure including at least a detailed item whose parent is the subject, and a detailed item whose parent is the detailed item,
the storage unit stores, in a non-volatile recording medium, a calculation coefficient for calculating a GHG emission amount based on the expense, the calculation coefficient being associated with the subject or the detailed item, and
boundary information indicating the subject or the detailed item that corresponds to an evaluation target and the subject or the detailed item that does not correspond to the evaluation target with respect to an evaluation index of environmental management, the boundary information indicating the correspondence/non-correspondence to the evaluation target of at least GHG calculation,
the boundary determination unit determines whether each record of the enterprise activity information corresponds or does not correspond to the evaluation target based on the boundary information, and
the evaluation unit determines an economic cost indicating the expense of the enterprise activity information, and
determines, based on the calculation coefficient, an environmental cost indicating the GHG emission amount for each record determined to correspond to the evaluation target of the GHG calculation.

2. The enterprise activity evaluation system for enterprise activities dealing with environmental management according to claim 1,
wherein the boundary determination unit performs the determination and adds a model coefficient to the record having the subject or the detailed item that does not fall under either of the correspondence/non-correspondence, and
the evaluation unit determines the environmental cost based on the model coefficient for the record where the model coefficient is set.

3. The enterprise activity evaluation system for enterprise activities dealing with environmental management according to claim 2,
wherein the boundary determination unit determines the model coefficient to be added to the record having the subject or the detailed item that does not fall under either of the correspondence/non-correspondence based on the evaluation index and one or more of the associated subject and detailed item.

4. The enterprise activity evaluation system for enterprise activities dealing with environmental management according to claim 1,
the enterprise activity evaluation system further comprising a case provision unit,
wherein the storage unit stores environmental activity case information in which an environmental activity case and the subject or the detailed item corresponding to the case are associated with each other,
the evaluation unit totalizes the GHG emission amount in the enterprise activity information based on the subject or the detailed item, and
the case provision unit determines a target subject or a target detailed item whose totalization result exceeds a threshold value, and determines a case to be presented based on the enterprise activity information, on the basis of the target subject or the target detailed item and the environmental activity case information.

5. The enterprise activity evaluation system for enterprise activities dealing with environmental management according to claim 4,
wherein the case provision unit receives designation of the subject or the detailed item by designation of the environmental activity case information, and
determines the case to be presented based on the designated subject or detailed item.

6. The enterprise activity evaluation system for enterprise activities dealing with environmental management according to claim 4,
wherein the storage unit stores environmental effect measurement information with which a threshold value for determining an environmental effect is associated, and
the case provision unit is configured to be able to determine, as the target subject or the target detailed item, one or a plurality of subjects or detailed items whose totalization result exceeds the threshold value and one or a plurality of subjects or detailed items whose totalization result falls below the threshold value based on the totalization result and the environmental effect measurement information, and to be able to determine the case based on the environmental activity case information for each of the determined target subject or target detailed item.

7. The enterprise activity evaluation system for enterprise activities dealing with environmental management according to claim 4,
wherein the storage unit further stores boundary information indicating whether the subject or the detailed item corresponds or does not correspond to a goal, or a goal and a target with respect to an evaluation index related to SDGs, and stores the environmental activity case information in association with the goal, or the goal and the target in addition to the subject or the detailed item,
the case provision unit receives designation of the goal or the target,
the boundary determination unit determines whether each record of the enterprise activity information corresponds or does not correspond to an evaluation target related to the SDGs based on the boundary information, and
the evaluation unit totalizes the GHG emission amount for each subject or each detailed item corresponding to the designated goal or target, for the record determined to correspond to the evaluation target related to the SDGs, allowing the case provision unit to determine the target subject or the target detailed item.

8. The enterprise activity evaluation system for enterprise activities dealing with environmental management according to claim 7,
wherein the case provision unit performs display processing at least one of a totalization result of the economic cost and the totalization result of the environmental cost for the goal and the target corresponding to the case and the subject or the detailed item corresponding to the case, in association with the case.

9. The enterprise activity evaluation system for enterprise activities dealing with environmental management according to claim 4, wherein
the enterprise activity evaluation system further comprising an analysis unit,
the storage unit stores an alternative detailed item capable of replacing the detailed item, an alternative economic cost that is an amount of money of the alternative detailed item, and an alternative calculation coefficient that is the calculation coefficient corresponding to the alternative detailed item,
the analysis unit retrieves the alternative detailed item for the record of the enterprise activity information, determines an economic cost and an environmental cost of the alternative detailed item based on the alternative economic cost and the alternative calculation coefficient, and
performs optimization processing including processing of determining the replacing alternative detailed item based on the economic cost and the environmental cost of the detailed item included in the enterprise activity information and the economic cost and the environmental cost of the alternative detailed item such that the totalization result of the environmental cost satisfies a reduction target, and at the same time, the totalization result of the economic cost or alternative points are minimized, and
the case provision unit performs display processing of an economic cost reduction amount and/or an environmental cost reduction amount obtained as a result of the optimization processing for each subject or each detailed item associated with the case, in association with the case.

10. (canceled)

11. An enterprise activity evaluation method for enterprise activities dealing with environmental management,
the method causing an enterprise activity evaluation system to execute: a reception step; a storage step; a boundary determination step; and an evaluation step,
wherein at the reception step, input of enterprise activity information including a subject and a detailed item, and its expense is received,
the detailed item having a hierarchical structure including at least a detailed item whose parent is the subject, and a detailed item whose parent is the detailed item,
at the storage step, a calculation coefficient for calculating a GHG emission amount based on the expense, the calculation coefficient being associated with the subject or the detailed item, and
boundary information indicating the subject or the detailed item that corresponds to an evaluation target and the subject or the detailed item that does not correspond to the evaluation target with respect to an evaluation index of environmental management, the boundary information indicating the correspondence/non-correspondence to the evaluation target of at least GHG calculation are stored in a non-volatile recording medium,
at the boundary determination step, whether each record of the enterprise activity information corresponds or does not correspond to the evaluation target is determined based on the boundary information, and
at the evaluation step, an economic cost indicating the expense of the enterprise activity information is determined, and
an environmental cost indicating the GHG emission amount for each record determined to correspond to the evaluation target of the GHG calculation is determined based on the calculation coefficient.
